(19) United States
(12) Patent Application Publication
(10) Pub. No.: US 2023/0010695 A1
(43) Pub. Date: Jan. 12, 2023

(54) ELECTRONIC AEROSOL PROVISION SYSTEM

(71) Applicant: Nicoventures Trading Limited, London (GB)

(72) Inventors: Jocelyn BENNING, London (GB); Kelly REES, London (GB); Walid ABI AOUN, London (GB)

(21) Appl. No.: 17/756,506

(22) PCT Filed: Nov. 27, 2020
(86) PCT No.: PCT/EP2020/083760

§ 371 Date: May 26, 2022

(30) Foreign Application Priority Data
Nov. 29, 2019 (GB) 1917467.1

(51) Int. Cl. A24F 40/40; A24F 40/57

(52) U.S. Cl. CPC A24F 40/40; A24F 40/57

(57) ABSTRACT

A method of generating aerosol from aerosol generating material using an aerosol provision device is disclosed. The method comprises supplying power to a heating element to begin heating the aerosol generating material to an operational temperature (e.g. a temperature at which aerosol is generated). After a first predetermined time period, the method provides a signal to a user to signify that the user may begin inhaling on the device. After a second predetermined time period or after a user has stopped inhaling, the method reduces the supply of power to the heating element. In this way a user can be guided as to when to inhale on a device. The timing may be adjusted to suit a particular delivery and/or device. Also described are aerosol provision devices and systems.

### PRIORITY CLAIM

The present application is a National Phase entry of PCT Application No. PCT/EP2020/083760, filed Nov. 27, 2020, which claims priority to Great Britain Application No. 1917467.1, filed Nov. 29, 2019, each of which is hereby fully incorporated herein by reference.

### TECHNICAL FIELD

The present disclosure relates to non-combustible aerosol provision systems.

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Other aerosol provision devices generate aerosol from a solid material, such as tobacco or a tobacco derivative. Such devices operate in a broadly similar manner to the liquid-based systems described above, in that the solid tobacco material is heated to a vaporization temperature to generate an aerosol which is subsequently inhaled by a user.

In heated systems, care is taken to ensure that the material being heated does not char or burn due to reaching excessive temperatures, and therefore create undesirable constituents that are delivered in the aerosol. On the other hand, some heated systems require a significant amount of time to reach an operating temperature.

Various approaches are described which seek to help address some of these issues.

### SUMMARY

According to a first aspect of certain embodiments there is provided a method of generating aerosol from aerosol generating material using an aerosol provision device, the method comprising: supplying power to a heating element to begin heating the aerosol generating material to an operational temperature; and after a first predetermined time period, providing a signal to a user to signify that the user may begin inhaling on the device; and after a second predetermined time period or after a user has stopped inhaling, reducing the supply of power to the heating element.

In some embodiments the operational temperature of the heating element is set based on the length of the first predetermined time period.

In some embodiments the operational temperature, Tₒₚ, of the heating element is determined as follows:

Tₒₚ=A−(B×t_{delay}),

where A and B are constants, and t_{delay} is the first predetermined time period.

In some embodiments, when the first predetermined time period is greater than zero seconds and less than 8 seconds, the heating element is heated to an operational temperature of between 200° C. to 350° C.

In some embodiments, when the first predetermined time is between 2 to 8 seconds, the heating element is heated to an operational temperature of between 200° C. to 270° C.

In some embodiments, when the first predetermined time period is between 2 to 8 seconds, the heating element is heated to an operational temperature of between 220° C. to 250° C.

In some embodiments, wherein when the first predetermined time period is between 0 to 2 seconds, the heating element is heated to an operational temperature of greater than 250° C. and/or greater than 270° C.

In some embodiments, wherein the heating element is heated to an operational temperature of no greater than 350° C.

According to an embodiment the method further comprises supplying power to the heating element prior to supplying power to the heating element during the first predetermined time period, wherein the power supplied prior to the first predetermined time period is set at a level such that the heating element is heated to a temperature below the operational temperature.

In some embodiments, the second predetermined time period is between 1 to 10 seconds.

In some embodiments, the aerosol generating material is an amorphous solid.

In some embodiments, the amorphous solid comprises: gelling agent in an amount of from about 1 wt % to about 60 wt %; tobacco extract in an amount of from about 10 wt % to about 60 wt %; aerosol generating agent in an amount of from about 5 wt % to about 60 wt %, wherein all percentages are measured on a dry weight basis.

In some embodiments, the thickness of the amorphous solid is between 0.05 mm to 0.4 mm.

In some embodiments, the signal is perceptible to the user by inhalation.

According to a second aspect of certain embodiments there is provided an aerosol provision device for generating aerosol from an aerosol generating material, the device comprising: a heating element; control circuitry; and an indicator, wherein the control circuitry is configured to: supply power to the heating element to cause the heating element to begin heating the aerosol generating material to an operational temperature; after a first predetermined time period, cause the indicator to provide a signal to a user to signify that the user may begin inhaling on the device; and after a second predetermined time period or after a user has stopped inhaling, reducing the supply of power to the heating element.

In some embodiments, the operational temperature of the heating element is set based on the length of the first predetermined time period.

In some embodiments, wherein the operational temperature, Tₒₚ, of the heating element is set as follows:

Tₒₚ=A−(B×t_{delay}),

where A and B are constants, and t_{delay} is the first predetermined time period.

In some embodiments, when the first predetermined time period is greater than zero seconds and less than 8 seconds, the control circuitry is configured to cause heating of the heating element to an operational temperature of between 200° C. to 350° C.

In some embodiments, when the first predetermined time period is between 2 to 5 seconds, the control circuitry is configured to cause heating of the heating element to an operational temperature of between 200° C. to 270° C.

In some embodiments, when the first predetermined time period is between 2 to 5 seconds, the control circuitry is configured to cause heating of the heating element to an operational temperature of between 220° C. to 250° C.

In some embodiments, when the first predetermined time period is between 0 to 2 seconds, control circuitry is configured to cause heating of the heating element to an operational temperature of greater than 250° C. and/or greater than 270° C.

In some embodiments, the control circuitry is configured to cause heating of the heating element to an operational temperature of no greater than 350° C.

In some embodiments, the control circuitry is configured to supply power to the heating element prior to supplying power to the heating element during the first predetermined time period, wherein the power supplied prior to the first predetermined time period is set at a level such that the heating element is heated to a temperature below the operational temperature.

In some embodiments, the second predetermined time period is between 1 to 10 seconds.

In some embodiments, the signal is perceptible to the user by inhalation.

In some embodiments, the operational temperature of the heating element is set based on the length of the first predetermined time period.

In some embodiments, the operational temperature, Tₒₚ, of the heating element is set as follows:

Tₒₚ=A−(B×t_{delay}),

where A and B are constants, and t_{delay} is the first predetermined timeperiod.

In some embodiments, when the first predetermined time period is greater than zero seconds and less than 8 seconds, the control circuitry is configured to cause heating of the heating element to an operational temperature of between 200° C. to 350° C.

In some embodiments, when the first predetermined time period is between 2 to 5 seconds, the control circuitry is configured to cause heating of the heating element to an operational temperature of between 200° C. to 270° C.

In some embodiments, when the first predetermined time period is between 2 to 5 seconds, the control circuitry is configured to cause heating of the heating element to an operational temperature of between 220° C. to 250° C.

In some embodiments, when the first predetermined time period is between 0 to 2 seconds, control circuitry is configured to cause heating of the heating element to an operational temperature of greater than 250° C. and/or greater than 270° C.

In some embodiments, the control circuitry is configured to cause heating of the heating element to an operational temperature of no greater than 350° C.

In some embodiments, the control circuitry is configured to supply power to the heating element prior to supplying power to the heating element during the first predetermined time period, wherein the power supplied prior to the first predetermined time period is set at a level such that the heating element is heated to a temperature below the operational temperature.

In some embodiments, the second predetermined time period is between 1 to 10 seconds.

In some embodiments, the signal is perceptible to the user by inhalation.

According to a third aspect of certain embodiments there is provided an aerosol provision system, the aerosol provision system comprising the aerosol provision device of the second aspect and aerosol generating material.

In some embodiments, the aerosol generating material is an amorphous solid.

In some embodiments, the amorphous solid comprises: gelling agent in an amount of from about 1 wt % to about 60 wt %; tobacco extract in an amount of from about 10 wt % to about 60 wt %; aerosol generating agent in an amount of from about 5 wt % to about 60 wt %, wherein all percentages are measured on a dry weight basis.

In some embodiments, the thickness of the amorphous solid is between 0.05 mm to 0.4 mm.

According to a fourth aspect of certain embodiments there is provided an aerosol provision device for generating aerosol from an aerosol generating material, the device comprising: heating means; control means; and indicator means, wherein the control means is configured to: supply power to the heating means to cause the heating means to begin heating the aerosol generating material to an operational temperature; after a first predetermined time period, cause the indicator means to provide a signal to a user to signify that the user may begin inhaling on the device; and after a second predetermined time period or after a user has stopped inhaling, reducing the supply of power to the heating means.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a cross-sectional view of a schematic representation of an aerosol provision system comprising an aerosol provision device and an aerosol generating article, the device comprising a plurality of heating elements and the article comprising a plurality of portions of aerosol generating material;

FIG. 2A is a top-down view of the aerosol generating article of FIG. 1;

FIG. 2B is an end-on view along the longitudinal (length) axis of the aerosol generating article of FIG. 1;

FIG. 2C is a side-on view along the width axis of the aerosol generating article of FIG. 1;

FIG. 3 is cross-sectional, top-down view of the heating elements of the aerosol provision device of FIG. 1;

FIG. 4a is a flow chart illustrating an exemplary method for generating an aerosol in accordance with aspects of the present disclosure, wherein the method includes heating for a predetermined time period before instructing a user to inhale on the device;

FIG. 4b is a graph showing the temperature of a given heating element when implementing the method of FIG. 4a;

FIG. 5 is an graph showing an exemplary heating profile implementing the method described in FIGS. 4a and 4b;

FIG. 6 is a top-down view of an exemplary touch sensitive panel for operating various functions of the aerosol provision system of FIG. 1;

FIG. 7 is a cross-sectional view of a schematic representation of an embodiment of an aerosol provision system comprising an aerosol provision device and a aerosol generating article, the device comprising a plurality of induction work coils and the article comprising a plurality of portions of aerosol generating material and corresponding susceptor portions;

FIG. 8A is a top-down view of the aerosol generating article of FIG. 7;

FIG. 8B is an end-on view along the longitudinal (length) axis of the aerosol generating article of FIG. 7; and

FIG. 8C is a side-on view along the width axis of the aerosol generating article of FIG. 7.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of examples and embodiments discussed herein which are not described in detail may be implemented in accordance with any conventional techniques for implementing such aspects and features.

The present disclosure relates to a “non-combustible” aerosol provision system. A “non-combustible” aerosol provision system is one where a constituent aerosolizable material of the aerosol provision system (or component thereof) is not combusted or burned in order to facilitate delivery of an aerosol to a user. Furthermore, and as is common in the technical field, the terms “vapor” and “aerosol”, and related terms such as “vaporize”, “volatilize” and “aerosolize”, may generally be used interchangeably.

In some implementations, the non-combustible aerosol provision system is an electronic cigarette, also known as a vaping device or electronic nicotine delivery system (END), although it is noted that the presence of nicotine in the aerosolizable material is not a requirement. Throughout the following description the terms “e-cigarette” or “electronic cigarette” are sometimes used but these terms may be used interchangeably with aerosol (vapor) provision system.

Typically, the non-combustible aerosol provision system may comprise a non-combustible aerosol provision device and an article (sometimes referred to as a consumable) for use with the non-combustible aerosol provision device. However, it is envisaged that articles which themselves comprise a means for powering an aerosol generating component may themselves form the non-combustible aerosol provision system.

The article, part or all of which, is intended to be consumed during use by a user. The article may comprise or consist of aerosolizable material (also referred to as an aerosol generating material). The article may comprise one or more other elements, such as a filter or an aerosol modifying substance (e.g. a component to add a flavor to, or otherwise alter the properties of, an aerosol that passes through or over the aerosol modifying substance).

Non-combustible aerosol provision systems often, though not always, comprise a modular assembly including both a reusable aerosol provision device and a replaceable article. In some implementations, the non-combustible aerosol provision device may comprise a power source and a controller (or control circuitry). The power source may, for example, be an electric power source, such as a battery or rechargeable battery. In some implementations, the non-combustible aerosol provision device may also comprise an aerosol generating component. However, in other implementations the article may comprise partially, or entirely, or consist of, the aerosol generating component.

In some implementations, the aerosol generating component is a heater capable of interacting with the aerosolizable material so as to release one or more volatiles from the aerosolizable material to form an aerosol. The heater (or a heating element) may comprise one or more electrically resistive heaters, including for example one or more nichrome resistive heater(s) and/or one or more ceramic heater(s). The one or more heaters may comprise one or more induction heaters which includes an arrangement comprising one or more susceptors which may form a chamber into which an article comprising aerosolizable material is inserted or otherwise located in use. Alternatively or in addition, one or more susceptors may be provided in the aerosolizable material. Other heating arrangements may also be used.

The article for use with the non-combustible aerosol provision device generally comprises an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In the following disclosure, the aerosolizable material is described as comprising an “amorphous solid”, which may alternatively be referred to as a “monolithic solid” (i.e. non-fibrous). In some implementations, the amorphous solid may be a dried gel. The amorphous solid is a solid material that may retain some fluid, such as liquid, within it. In some implementations, the aerosolizable material may for example comprise from about 50 wt %, 60 wt % or 70 wt % of amorphous solid, to about 90 wt %, 95 wt % or 100 wt % of amorphous solid. However, it should be appreciated that principles of the present disclosure may be applied to other aerosolizable materials, such as tobacco, reconstituted tobacco, a liquid, such as an e-liquid, etc.

As appropriate, the aerosolizable material or amorphous solid may comprise any one or more of: an active constituent, a carrier constituent, a flavor, and one or more other functional constituents.

The active constituent as used herein may be a physiologically active material, which is a material intended to achieve or enhance a physiological response. The active constituent may for example be selected from nutraceuticals, nootropics, psychoactives. The active constituent may be naturally occurring or synthetically obtained. The active constituent may comprise for example nicotine, caffeine, taurine, thiene, vitamins such as B6 or B12 or C, melatonin, cannabinoids, or constituents, derivatives, or combinations thereof. The active constituent may comprise one or more constituents, derivatives or extracts of tobacco, cannabis or another botanical. As noted herein, the active constituent may comprise one or more constituents, derivatives or extracts of cannabis, such as one or more cannabinoids or terpenes.

In some embodiments, the active constituent comprises nicotine. In some embodiments, the active constituent comprises caffeine, melatonin or vitamin B12.

In some embodiments, the aerosol-generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT). The aerosol-generating material may comprise one or more cannabinoid compounds selected from the group consisting of cannabidiol (CBD) and THC (tetrahydrocannabinol). The aerosol-generating material may comprise cannabidiol (CBD). The aerosol-generating material may comprise nicotine and cannabidiol (CBD).

As noted herein, the active constituent may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Exemplary botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arvensis, Mentha c.v., Mentha niliaca, Mentha piperita, Mentha piperita citrata c.v., Mentha piperita c.v, Mentha spicata crispa, Mentha cordifolia, Mentha longifolia, Mentha suaveolens variegata, Mentha pulegium, Mentha spicata c.v. and Mentha suaveolens

In some embodiments, the active constituent comprises or is derived from one or more botanicals or constituents, derivatives or extracts thereof and the botanical is tobacco.

In some embodiments, the active constituent comprises or derived from one or more botanicals or constituents, derivatives or extracts thereof and the botanical is selected from eucalyptus, star anise, cocoa and hemp.

In some embodiments, the active constituent comprises or derived from one or more botanicals or constituents, derivatives or extracts thereof and the botanical is selected from rooibos and fennel.

In some implementations, the aerosolizable material comprises a flavor (or flavorant).

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol (e.g., an aerosol former). In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The aerosol generating material or amorphous solid may comprise an aerosol former. In some embodiments, the aerosol former comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

The one or more other functional constituents may comprise one or more of pH regulators, coloring agents, preservatives, binders, fillers, stabilizers, and/or antioxidants.

The aerosolizable material may be present on or in a carrier support (or carrier component) to form a substrate. The carrier support may, for example, be or comprise paper, card, paperboard, cardboard, reconstituted aerosolizable material, a plastics material, a ceramic material, a composite material, glass, a metal, or a metal alloy.

In some implementations, the article for use with the non-combustible aerosol provision device may comprise aerosolizable material or an area for receiving aerosolizable material. In some implementations, the article for use with the non-combustible aerosol provision device may comprise a mouthpiece, or alternatively the non-combustible aerosol provision device may comprise a mouthpiece which communicates with the article. The area for receiving aerosolizable material may be a storage area for storing aerosolizable material. For example, the storage area may be a reservoir.

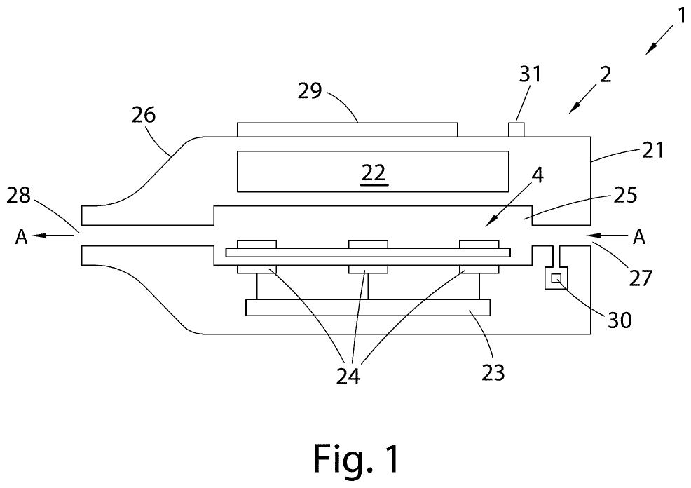

FIG. 1 is a cross-sectional view through a schematic representation of an aerosol provision system 1 in accordance with certain embodiments of the disclosure. The aerosol provision system 1 comprises two main components, namely an aerosol provision device 2 and an aerosol generating article 4.

The aerosol provision device 2 comprises an outer housing 21, a power source 22, control circuitry 23, a plurality of aerosol generating components 24, a receptacle 25, an inhalation or mouthpiece end 26, an air inlet 27, an air outlet 28, a touch-sensitive panel 29, an inhalation sensor 30, and an indicator unit 31.

The outer housing 21 may be formed from any suitable material, for example a plastics material. The outer housing 21 is arranged such that the power source 22, control circuitry 23, aerosol generating components 24, receptacle 25 and inhalation sensor 30 are located within the outer housing 21. The outer housing 21 also defines the air inlet 27 and air outlet 28, described in more detail below. The touch sensitive panel 29 and end of use indicator are located on the exterior of the outer housing 21.

The outer housing 21 may further include an inhalation or a mouthpiece end 26. The outer housing 21 and mouthpiece end 26 may be formed as a single component (that is, the mouthpiece end 26 may form a part of the outer housing 21). The inhalation or mouthpiece end 26 is defined as a region of the outer housing 21 which includes the air outlet 28 and may be shaped in such a way that a user may comfortably place their lips around the mouthpiece end 26 to engage with air outlet 28. In FIG. 1, the thickness of the outer housing 21 decreases towards the air outlet 28 to provide a relatively thinner portion of the aerosol provision device 2 which may be more easily accommodated by the lips of a user. In other implementations, however, the mouthpiece end 26 may be a removable component that is separate from, but able to be coupled to, the outer housing 21 and may be removed for cleaning and/or replacement with another mouthpiece end 26. The mouthpiece end 26 may, for example, be formed as part of the aerosol generating article 4.

The power source 22 is configured to provide operating power to the aerosol provision device 2. The power source 22 may be any suitable power source, such as a battery. For example, the power source 22 may comprise a rechargeable battery, such as a Lithium Ion battery. The power source 22 may be removable or form an integrated part of the aerosol provision device 2. In some implementations, the power source 22 may be recharged through connection of the device 2 to an external power supply (such as mains power) through an associated connection port, such as a USB port (not shown) or via a suitable wireless receiver (not shown).

The control circuitry 23 is suitably configured/programmed to control the operation of the aerosol provision device to provide certain operating functions of aerosol provision device 2. The control circuitry 23 may be considered to logically comprise various sub-units/circuitry elements associated with different aspects of the operation of aerosol provision device 2. For example, the control circuitry 23 may comprise a logical sub-unit for controlling the recharging of the power source 22. Additionally, the control circuitry 23 may comprise a logical sub-unit for communication, e.g., to facilitate data transfer from or to the aerosol provision device 2. However, a primary function of the control circuitry 23 is to control the aerosolization of aerosol generating material, as described in more detail below. It will be appreciated the functionality of the control circuitry 23 can be provided in various different ways, for example using one or more suitably programmed programmable computer(s) and/or one or more suitably configured application-specific integrated circuit(s)/circuitry/chip(s)/chipset(s) configured to provide the desired functionality. The control circuitry 23 is connected to the power source 22 and receives power from the power source 22 and may be configured to distribute or control the power supply to other components of the aerosol provision device 2.

In the described implementation, the aerosol provision device 2 further comprises a receptacle 25 which is arranged to receive an aerosol generating article 4.

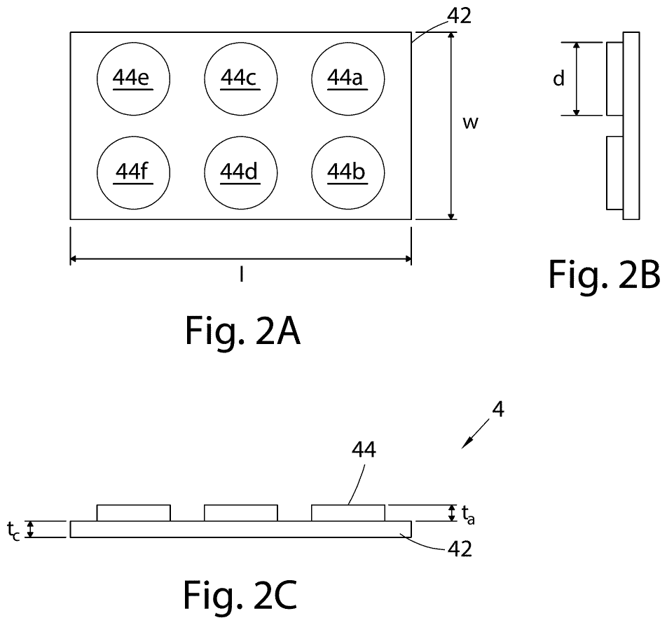

The aerosol generating article 4 comprises a carrier component 42 and aerosol generating material 44. The aerosol generating article 4 is shown in more detail in FIGS. 2A to 2C. FIG. 2A is a top-down view of the aerosol generating article 4, FIG. 2B is an end-on view along the width axis of the aerosol generating article 4, and FIG. 2C is a side-on view along the longitudinal (length) axis of the aerosol generating article 4.

The aerosol generating article 4 comprises a carrier component 42 which in this implementation is formed of card. The carrier component 42 forms the majority of the aerosol generating article 4, and acts as a base for the aerosol generating material 44 to be deposited on.

The carrier component 42 is broadly cuboidal in shape has a length 1, a width w and a thickness t_{c} as shown in FIGS. 2A to 2C. By way of a concrete example, the length of the carrier component 42 may be 30 mm to 80 mm, the width may be 7 mm to 25 mm, and the thickness may be between 0.2 mm to 1 mm. However, it should be appreciated that the above are exemplary dimensions of the carrier component 42, and in other implementations the carrier component 42 may have different dimensions as appropriate. In some implementations, the carrier component 42 may comprise one or more protrusions extending in the length and/or width directions of the carrier component 42 to help facilitate handling of the aerosol generating article 4 by the user.

In the example shown in FIGS. 1 and 2, the aerosol generating article 4 comprises a plurality of discrete portions of aerosol generating material 44 disposed on a surface of the carrier component 42. More specifically, the aerosol generating article 4 comprises six discrete portions of aerosol generating material 44, labelled 44a to 44f, disposed in a two by three array. However, it should be appreciated that in other implementations a greater or lesser number of discrete portions may be provided, and/or the portions may be disposed in a different array (e.g., a one by six array). In the example shown, the aerosol generating material 44 is disposed at discrete, separate locations on a single surface of the carrier component 42. The discrete portions of aerosol generating material 44 are shown as having a circular footprint, although it should be appreciated that the discrete portions of aerosol generating material 44 may take any other footprint, such as square, triangular, hexagonal or rectangular, as appropriate. The discrete portions of aerosol generating material 44 have a diameter d and a thickness tₐ as shown in FIGS. 2A to 2C. The thickness ta may take any suitable value, for example the thickness tₐ may be in the range of 50 μm to 1.5 mm. In some embodiment, the thickness ta is from about 50 μm to about 200 μm, or about 50 μm to about 100 μm, or about 60 μm to about 90 μm, suitably about 77 μm. In other embodiments, the thickness ta may be greater than 200 μm, e.g., from about 50 μm to about 400 μm, or to about 1 mm, or to about 1.5 mm.

The discrete portions of aerosol generating material 44 are separate from one another such that each of the discrete portions may be energized (e.g., heated) individually/selectively to produce an aerosol. In some implementations, the portions of aerosol generating material 44 may have a mass no greater than 20 mg, such that the amount of material to be aerosolized by a given aerosol generating component 24 at any one time is relatively low. For example, the mass per portion may be equal to or lower than 20 mg, or equal to or lower than 10 mg, or equal to or lower than 5 mg. Of course, it should be appreciated that the total mass of the aerosol generating article 4 may be greater than 20 mg.

In the described implementation, the aerosol generating material 44 is an amorphous solid. Generally, the aerosol generating material 44 or amorphous solid may comprise a gelling agent (sometimes referred to as a binder) and an aerosol generating agent (which might comprise glycerol, for example). The gelling agent may comprise one or more compounds selected from cellulosic gelling agents, non-cellulosic gelling agents, guar gum, acacia gum and mixtures thereof. In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof. In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum. In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

The gelling agent may further comprise a setting agent (e.g., a calcium source). In certain implementations, the setting agent comprises or consists of calcium acetate, calcium formate, calcium carbonate, calcium hydrogencarbonate, calcium chloride, calcium lactate, or a combination thereof. In certain implementations, the setting agent comprises or consists of calcium formate and/or calcium lactate. In particular examples, the setting agent comprises or consists of calcium formate. The inventors have identified that, typically, employing calcium formate as a setting agent results in an amorphous solid having a greater tensile strength and greater resistance to elongation.

The aerosol generating material 44 or amorphous solid may comprise one or more of the following: an active substance (which may include a tobacco extract), a flavorant, an acid, and a filler. Other components may also be present as desired. In certain embodiments, the aerosol-generating material 44 or amorphous solid comprises a gelling agent comprising a cellulosic gelling agent and/or a non-cellulosic gelling agent, an active substance and an acid.

The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid. In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid. Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid. The inclusion of an acid is particularly preferred in embodiments in which the aerosol-generating material 44 comprises nicotine. In such embodiments, the presence of an acid may stabilize dissolved species in the slurry from which the aerosol-generating material 44 is formed. The presence of the acid may reduce or substantially prevent evaporation of nicotine during drying of the slurry, thereby reducing loss of nicotine during manufacturing.

The amorphous solid may comprise a colorant. The addition of a colorant may alter the visual appearance of the amorphous solid. The presence of colorant in the amorphous solid may enhance the visual appearance of the amorphous solid and the aerosol-generating material. By adding a colorant to the amorphous solid, the amorphous solid may be color-matched to other components of the aerosol-generating material or to other components of an article comprising the amorphous solid.

A variety of colorants may be used depending on the desired color of the amorphous solid. The color of amorphous solid may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosol-generating material 44 comprising the amorphous solid. In some embodiments, the addition of a colorant to the amorphous solid renders it visually indistinguishable from other components in the aerosol-generating material 44.

The colorant may be incorporated during the formation of the amorphous solid (e.g. when forming a slurry comprising the materials that form the amorphous solid) or it may be applied to the amorphous solid after its formation (e.g. by spraying it onto the amorphous solid).

An amorphous solid aerosolizable material offers some advantages over other types of aerosolizable materials commonly found in some electronic aerosol provision devices. For example, compared to electronic aerosol provision devices which aerosolize a liquid aerosolizable material, the potential for the amorphous solid to leak or otherwise flow from a location at which the amorphous solid is stored is greatly reduced. This means aerosol provision devices or articles may be more cheaply manufactured as the components do not necessarily require the same liquid-tight seals or the like to be used.

Compared to electronic aerosol provision devices which aerosolize a solid aerosolizable material, e.g., tobacco, a comparably lower mass of amorphous solid material can be aerosolized to generate an equivalent amount of aerosol (or to provide an equivalent amount of a constituent in the aerosol, e.g., nicotine). This is partially due to the fact that an amorphous solid can be tailored to not include unsuitable constituents that might be found in other solid aerosolizable materials (e.g., cellulosic material in tobacco, for example). For example, in some implementations, the mass per portion of amorphous solid is no greater than 20 mg, or no greater than 10 mg, or no greater than 5 mg. Accordingly, the aerosol provision device 2 can supply relatively less power to the aerosol generating article 4 and/or the aerosol generating article 4 can be comparably smaller to generate a similar aerosol, thus meaning the energy requirements for the aerosol provision device 2 may be reduced.

In some embodiments, the amorphous solid comprises tobacco extract. In these embodiments, the amorphous solid may have the following composition (by Dry Weight Basis, DWB): gelling agent (preferably comprising alginate) in an amount of from about 1 wt % to about 60 wt %, or about 10 wt % to 30 wt %, or about 15 wt % to about 25 wt %; tobacco extract in an amount of from about 10 wt % to about 60 wt %, or from about 40 wt % to 55 wt %, or from about 45 wt % to about 50 wt %; aerosol generating agent (preferably comprising glycerol) in an amount of from about 5 wt % to about 60 wt %, or from about 20 wt % to about 40 wt %, or from about 25 wt % to about 35 wt % (DWB). The tobacco extract may be from a single variety of tobacco or a blend of extracts from different varieties of tobacco. Such amorphous solids may be referred to as “tobacco amorphous solids”, and may be designed to deliver a tobacco-like experience when aerosolized.

In one embodiment, the amorphous solid comprises about 20 wt % alginate gelling agent, about 48 wt % Virginia tobacco extract and about 32 wt % glycerol (DWB).

The amorphous solid of these embodiments may have any suitable water content. For example, the amorphous solid may have a water content of from about 5 wt % to about 15 wt %, or from about 7 wt % to about 13 wt %, or about 10 wt %.

Suitably, in any of these embodiments, the amorphous solid has a thickness tₐ of from about 50 μm to about 200 μm, or about 50 μm to about 100 μm, or about 60 μm to about 90 μm, suitably about 77 μm.

In some implementations, the amorphous solid may comprise 0.5-60 wt % of a gelling agent; and 5-80 wt % of an aerosol generating agent (DWB). Such amorphous solids may contain no flavor, no acid and no active substance. Such amorphous solids may be referred to as “aerosol generating agent rich” or “aerosol generating agent amorphous solids”. More generally, this is an example of an aerosol generating agent rich aerosol generating material 44 which, as the name suggests, is a portion of aerosol generating material 44 which is designed to deliver aerosol generating agent when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB).

In some other implementations, the amorphous solid may comprise 0.5-60 wt % of a gelling agent; 5-80 wt % of an aerosol generating agent; and 1-60 wt % of a flavor (DWB). Such amorphous solids may contain flavor, but no active substance or acid. Such amorphous solids may be referred to as “flavorant rich” or “flavor amorphous solids”. More generally, this is an example of a flavorant rich aerosol generating material 44 which, as the name suggests, is a portion of aerosol generating material 44 which is designed to deliver flavorant when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), flavor in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 5-60 wt % of at least one active substance (DWB). Such amorphous solids may contain an active substance, but no flavor or acid. Such amorphous solids may be referred to as “active substance rich” or “active substance amorphous solids”. For example, in one implementation, the active substance may be nicotine, and as such an amorphous solid as described above comprising nicotine may be referred to as a “nicotine amorphous solid”. More generally, this is an example of an active substance rich aerosol generating material 44 which, as the name suggests, is a portion of aerosol generating material 44 which is designed to deliver an active substance when aerosolized.

In these implementations, amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), active substance in an amount of from about 30 wt % to about 60 wt %, or from about 40 wt % to 55 wt %, or from about 45 wt % to about 50 wt %.

In some other implementations, the amorphous solid may comprise 0.5-60 wt % of a gelling agent; 5-80 wt % of an aerosol generating agent; and 0.1-10 wt % of an acid (DWB) Such amorphous solids may contain acid, but no active substance and flavorant. Such amorphous solids may be referred to as “acid rich” or “acid amorphous solids”. More generally, this is an example of an acid rich aerosol generating material 44 which, as the name suggests, is a portion of aerosol generating material 44 which is designed to deliver an acid when aerosolized.

In these implementations, the amorphous solid may have the following composition (DWB): gelling agent in an amount of from about 5 wt % to about 40 wt %, or about 10 wt % to 30 wt %, or about 15 wt % to about 25 wt %; aerosol generating agent in an amount of from about 10 wt % to about 50 wt %, or from about 20 wt % to about 40 wt %, or from about 25 wt % to about 35 wt % (DWB), acid in an amount of from about 0.1 wt % to about 8 wt %, or from about 0.5 wt % to 7 wt %, or from about 1 wt % to about 5 wt %, or form about 1 wt % to about 3 wt %.

The aerosol generating article 4 may comprise a plurality of portions of aerosol generating material 44 all formed form the same aerosol generating material (e.g., one of the amorphous solids described above). Alternatively, the aerosol generating article 4 may comprise a plurality of portions of aerosol generating material 44 where at least two portions are formed from different aerosol generating material 44 (e.g., one of the amorphous solids described above).

The receptacle 25 is suitably sized to removably receive the aerosol generating article 4 therein. Although not shown, the aerosol provision device 2 may comprise a hinged door or removable part of the outer housing 21 to permit access to the receptacle 25 such that a user may insert and/or remove the aerosol generating article 4 from the receptacle 25. The hinged door or removable part of the outer housing 21 may also act to retain the aerosol generating article 4 within the receptacle 25 when closed. When the aerosol generating article 4 is exhausted or the user simply wishes to switch to a different aerosol generating article 4, the aerosol generating article 4 may be removed from the aerosol provision device 2 and a replacement aerosol generating article 4 positioned in the receptacle 25 in its place. Alternatively, the aerosol provision device 2 may include a permanent opening that communicates with the receptacle 25 and through which the aerosol generating article 4 can be inserted into the receptacle 25. In such implementations, a retaining mechanism for retaining the aerosol generating article 4 within the receptacle 25 of the aerosol provision device 2 may be provided.

As seen in FIG. 1, the aerosol provision device 2 comprises a number of aerosol generating components 24. In the described implementation, the aerosol generating components 24 are heating elements 24, and more specifically resistive heating elements 24. Resistive heating elements 24 receive an electrical current and convert the electrical energy into heat. The resistive heating elements 24 may be formed from, or comprise, any suitable resistive heating material, such as NiChrome (Ni20Cr80), which generates heat upon receiving an electrical current. In one implementation, the heating elements 24 may comprise an electrically insulating substrate on which resistive tracks are disposed.

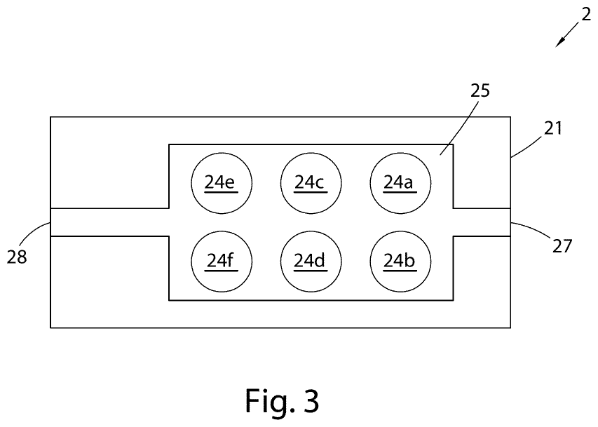

FIG. 3 is a cross-sectional, top-down view of the aerosol provision device 2 showing the arrangement of the heating elements 24 in more detail. In FIGS. 1 and 3, the heating elements 24 are positioned such that a surface of a heating element 24 forms a part of the surface of the receptacle 25. That is, an outer surface of a heating element 24 is flush with the inner surface of the receptacle. More specifically, the outer surface of the heating element 24 that is flush with the inner surface of the receptacle 25 is a surface of the heating element 24 that is heated (i.e., its temperature increases) when an electrical current is passed through the heating element 24.

In the present example, the heating element 24 is formed of an electrically-conductive plate, which defines the surface of the heating element that is arranged to increase in temperature. The electrically-conductive plate may be formed of a metallic material, for example, NiChrome, which generates heat when a current is passed through the electrically-conductive plate. In other implementations, a separate electrically-conductive track may pass on a surface of, or through, a second material (e.g., a metal material or a ceramic material), with the electrically-conductive track generating heat that is transferred to the second material. That is, the second material in combination with the electrically-conductive track forms the heating element 24. In the latter example, the surface of the heating element that is arranged to increase in temperature is defined by the perimeter of the second material.

In the described implementation, the surfaces of the heating elements 24 that are arranged to increase in temperature are also planar and are generally located in a plane parallel to the wall of the receptacle 25. However, in other implementations, the surfaces may be curved; that is to say, the plane in which the surfaces of the heating elements 24 are located may have a radius of curvature in one axis (e.g., the surface may be approximately parabolic). The heating elements 24 are arranged such that, when the aerosol generating article 4 is received in the receptacle 25, each heating element 24 aligns with a corresponding discrete portion of aerosol generating material 44. Hence, in this example, six heating elements 24 are arranged in a two by three array broadly corresponding to the arrangement of the two by three array of the six discrete portions of aerosol generating material 44 shown in FIGS. 2A. However, as discussed above, the number of heating elements 24 may be different in different implementations, for example there may be 8, 10, 12, 14, etc. heating elements 24. In some implementations, the number of heating elements 24 is greater than or equal to six but no greater than 20.

More specifically, the heating elements 24 are labelled 24a to 24f in FIG. 3, and it should be appreciated that each heating element 24 is arranged to align with a corresponding portion of aerosol generating material 44 as denoted by the corresponding letter following the references 24/44. Accordingly, each of the heating elements 24 can be individually activated to heat a corresponding portion of aerosol generating material 44.

While the heating elements 24 are shown flush with the inner surface of the receptacle 25, in other implementations the heating elements 24 may protrude into the receptacle 25. In either case, the aerosol generating article 4 contacts the surfaces of the heating elements 24 when present in the receptacle 25 such that heat generated by the heating elements 24 is conducted to the aerosol generating material 44 through the carrier component 42.

In some implementations, to improve the heat-transfer efficiency, the receptacle may comprise components which apply a force to the surface of the carrier component 42 so as to press the carrier component 42 onto the heater elements 24, thereby increasing the efficiency of heat transfer via conduction to the aerosol generating material 44. Additionally or alternatively, the heater elements 24 may be configured to move in the direction towards/away from the aerosol generating article 4, and may be pressed into the surface of carrier component 42 that does not comprise the aerosol generating material 44.

In use, the aerosol provision device 2 (and more specifically the control circuitry 23) is configured to deliver power to the heating elements 24 in response to a user input. Broadly speaking, the control circuitry 23 is configured to selectively apply power to the heating elements 24 to subsequently heat the corresponding portions of aerosol generating material 44 to generate aerosol. When a user inhales on the aerosol provision device 2 (i.e., inhales at mouthpiece end 26), air is drawn into the aerosol provision device 2 through air inlet 27, into the receptacle 25 where it mixes with the aerosol generated by heating the aerosol generating material 44, and then to the user's mouth via air outlet 28. That is, the aerosol is delivered to the user through mouthpiece end 26 and air outlet 28.

The aerosol provision device 2 of FIG. 1 includes a touch-sensitive panel 29 and an inhalation sensor 30. Collectively, the touch-sensitive panel 29 and inhalation sensor 30 act as mechanisms for a receiving a user input to cause the generation of aerosol, and thus may more broadly be referred to as user input mechanisms. The received user input may be said to be indicative of a user's desire to generate an aerosol.

The touch-sensitive panel 29 may be a capacitive touch sensor and can be operated by a user of the aerosol provision device 2 placing their finger or another suitably conductive object (for example a stylus) on the touch-sensitive panel 29. In the described implementation, the touch-sensitive panel 29 includes a region which can be pressed by a user to start aerosol generation. The control circuitry 23 may be configured to receive signaling from the touch-sensitive panel 29 and to use this signaling to determine if a user is pressing (i.e. activating) the region of the touch-sensitive panel 29. If the control circuitry 23 receives this signaling, then the control circuitry 23 is configured to supply power from the power source 22 to one or more of the heating elements 24. Power may be supplied for a predetermined time period (for example, three seconds) from the moment a touch is detected, or in response to the length of time the touch is detected for. In other implementations, the touch sensitive panel 29 may be replaced by a user actuatable button (not shown) or the like.

The inhalation sensor 30 may be a pressure sensor or microphone or the like configured to detect a drop in pressure or a flow of air caused by the user inhaling on the aerosol provision device 2. The inhalation sensor 30 is located in fluid communication with the air flow pathway (that is, in fluid communication with the air flow path between air inlet 27 and air outlet 28). In a similar manner as described above, the control circuitry 23 may be configured to receive signaling from the inhalation sensor 30 and to use this signaling to determine if a user is inhaling on the aerosol provision system 1. If the control circuitry 23 receives this signaling, then the control circuitry 23 is configured to supply power from the power source 22 to one or more of the heating elements 24. Power may be supplied for a predetermined time period (for example, three seconds) from the moment inhalation is detected, or in response to the length of time the inhalation is detected for.

In the described example, both the touch-sensitive panel 29 and inhalation sensor 30 detect the user's desire to begin generating aerosol for inhalation. The control circuitry 23 may be configured to only supply power to the heating element 24 when signaling from both the touch-sensitive panel 29 and inhalation sensor 30 are detected. This may help prevent inadvertent activation of the heating elements 24 from accidental activation of one of the user input mechanisms. However, in other implementations, the aerosol provision system 1 may have only one of a touch sensitive panel 29 and an inhalation sensor 30.

These aspects of the operation of the aerosol provision system 1 (i.e. puff detection and touch detection) may in themselves be performed in accordance with established techniques (for example using conventional inhalation sensor and inhalation sensor signal processing techniques and using conventional touch sensor and touch sensor signal processing techniques).

In the implementation of the aerosol provision system 1 described above, a plurality of (discrete) portions of aerosol generating material 44 are provided which can be selectively aerosolized using the one or more aerosol generating components 24, as described in more detail below. Such aerosol provision systems 1 offer advantages over other systems which are designed to heat a larger bulk quantity of material. In particular, for a given inhalation, only the selected portion (or portions) of aerosol generating material 44 are aerosolized leading to a more energy efficient system overall.

In heated systems, several parameters affect the overall effectiveness of the system at delivering a sufficient amount of aerosol to a user on a per puff basis. On the one hand, the thickness of the aerosol generating material 44 may be important as this may influence how quickly the aerosol generating material 44 reaches an operational temperature (and subsequently generates aerosol). This may be important for several reasons, but may lead to more efficient use of energy from the power source 22 as the heating element 24 may not need to be active for as long compared with heating a thicker portion of aerosol generating material 44. On the other hand, the total mass of the aerosol generating material 44 that is heated may affect the total amount of aerosol that can be generated, and subsequently delivered to the user. In addition, the temperature that the aerosol generating material 44 is heated too may affect both how quickly the aerosol generating material 44 reaches operational temperature and the amount of aerosol that is generated.

Amorphous solids (e.g., as described above) are particularly suited to the above application, in part because the amorphous solids are formed from selected ingredients/constituents and so can be engineered such that a relatively high proportion of the mass is the useful (or deliverable) constituents (e.g., nicotine and glycerol, for example). As such, amorphous solids may produce a relatively high proportion of aerosol from a given mass as compared to some other aerosol generating materials (e.g., tobacco), meaning that relatively smaller portions of amorphous solid can output a comparable amount of aerosol. In addition, amorphous solids do not tend to easily flow (if at all) which means problems around leakage when using a liquid aerosol generating material, for example, are largely mitigated.

In the systems described above, the aerosol generating portions are supplied with energy from the aerosol generating components 24 (e.g., heating elements 24) to cause the aerosol generating material 44 to generate an aerosol for user inhalation. With heating elements 24, assuming all other conditions are the same, the duration for which the heating elements 24 are heating a portion of aerosol generating material 44 and the temperature the heating elements 24 are controlled to operate at influence the total energy that can be applied to the portion of aerosol generating material 44. For example, a greater amount of energy can be applied when the heating element 24 is activated for longer and/or to a higher temperature, assuming all other conditions are the same. The energy applied may be proportional to the mass of aerosol that is generated.

In addition, as mentioned above, the rate at which energy passes to the aerosol generating material 44 is based, in part, on the temperature to which the portion of aerosol generating material 44 is being heated to—that is, a hotter heating element 24 imparts energy more quickly. Therefore, to obtain a large amount of aerosol in a relatively short time period, a hotter heating element 24 is required. However, the aerosol generating material 44 typically has a not-insignificant thickness such that there may be a temperature gradient across the thickness of the aerosol generating material 44 when the aerosol generating material 44 is heated from one side. The surface contacting or closest to the heating element 24 may be at a greater temperature than the opposing surface. If the temperature of part of the aerosol generating material 44 is raised beyond a certain point, there is a greater likelihood of generating off-notes or unpleasant tastes in the generated aerosol due to charring of the material.

Additionally, independently of the practical limitations caused by charring the aerosol generating material 44 at high temperatures, the way in which certain constituents may be released from the aerosolizable material (i.e., converted into aerosol) may be dependent on the temperature to which the aerosolizable material is heated to. For example, the taste or general user experience when inhaling aerosol generated by heating a tobacco amorphous solid as described above can vary based on the temperature to which the tobacco amorphous solid is heated to. For example, tobacco (or tobacco extract) may contain a plurality of different constituents which are released at different times and/or in different proportions when heated at different temperatures. Thus, for certain types of tobacco and/or for certain user preferences, heating the aerosol generating material 44 to a lower temperature may be desirable. However, as specified above, the total energy imparted to the aerosolizable material effects the amount of aerosol that is subsequently generated from a portion of aerosolizable material. Although tobacco amorphous solids have been described above, it should be appreciated that the same principles apply to other aerosol generating materials which have one or more constituents that affect taste or user experience when heated.

Thus, the inventors have found that, by starting heating prior to a user inhaling on the device, a lower temperature heating element can be used to generate suitable quantities of aerosol but with fewer off-notes in the taste and/or suitable quantities of aerosol at the desired lower temperature taste profile.

In particular, the inventors have proposed a method of generating aerosol from aerosol generating material 44 that includes the steps of: supplying power to a heating element 24 to begin heating the aerosol generating material 44; after a first predetermined time period, providing a signal to a user to signify that the user may begin inhaling on the device; and after a second predetermined time period or after a user has stopped inhaling, reducing the supply of power to the heating element24.

The first predetermined time period and the power can be controlled in advance such that a similar amount of aerosol can be generated per inhalation by either increasing the first predetermined time period and reducing the temperature of the heating element 24, or decreasing the first predetermined time period and increasing the temperature of the heating element 24. The temperature of the heating element 24 is dependent, in part, on the electrical power supplied to the heating element.

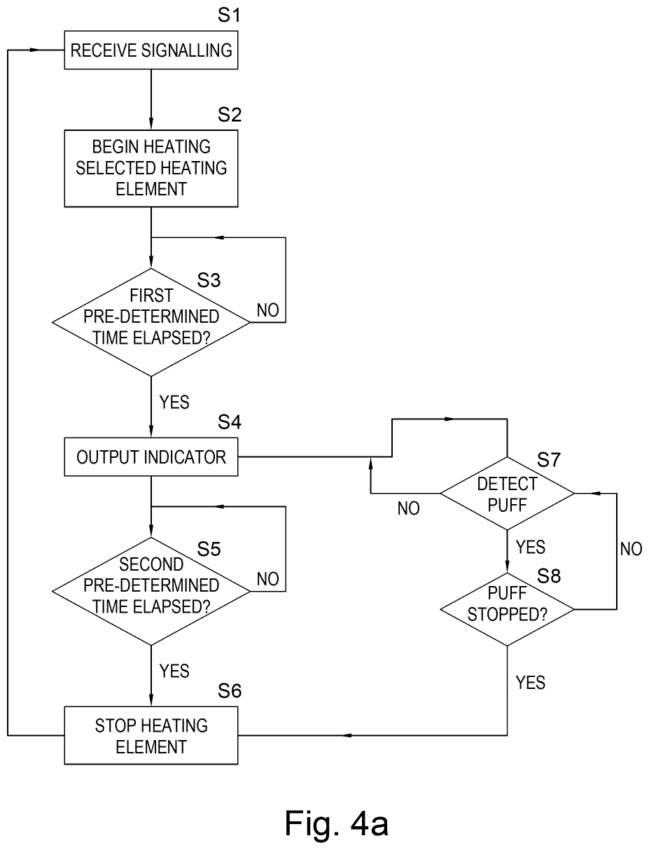

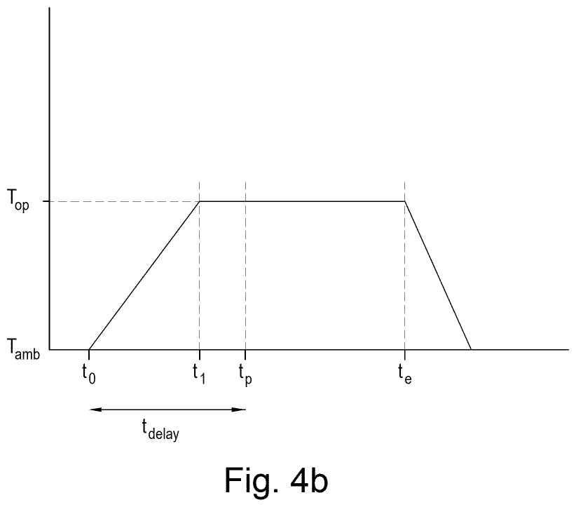

FIG. 4a is a flow chart depicting a method of aerosol generation in accordance with the present disclosure. FIG. 4b is a graph showing time (t) on the x-axis and the temperature of a given heating element 24 (T) on the y-axis. The following will refer to both FIG. 4a and FIG. 4b.

The method starts at step S1, where the aerosol provision device 2 receives signaling from, in this implementation, the touch-sensitive panel 29 signifying a user's intention to inhale aerosol, as discussed above. The aerosol provision device 2 may already be in a “stand-by” state prior to step S1 and as such the control circuitry 23 is in a state where it is monitoring for the signaling. This is shown at to in FIG. 4b.

When the signaling is received at step S1 and at time to, the control circuitry 23 is configured to start heating (i.e., start supplying power to) the selected heating element 24 at step S2. In FIG. 4b, the heater temperature starts to increase from an ambient temperature T_{amb} to an operational temperature Tₒₚ. However, and as mentioned in more detail below, the heating operation may not start from ambient temperature but may start from a greater temperature which may be as a result of a pre-heat phase or warming of the heating element 24 from an adjacent heating element 24 previously heated.

As discussed above, the aerosol generating material 44 may be capable of generating aerosol at a range of temperatures (e.g., 230° C. to 290° C.). The term operational temperature as used herein should be understood to mean a temperature (or temperatures) at which the aerosol generating material 44 is able to generate aerosol. In FIG. 4b, Tₒₚ is shown as a single value and this may also be referred to as the target operational temperature, i.e., the specific temperature the heating element 24 is controlled to reach. This may be set in advance by a user or manufacture and may be a fixed or variable value as desired.

In this regard, the selected heating element 24 may be a single heating element 24 or may be multiple heating elements 24 depending upon the implementation at hand (described in more detail below). The control circuitry 23 may supply a certain level of power so as to reach the certain target operational temperature Tₒₚ with the heating element 24, where it should be appreciated that a greater power supplied generally leads to a greater temperature reached. As mentioned, the operational temperature is a temperature set in advance at which the heating element 24 is set to operate at in order to generate an aerosol from the aerosol generating material 44.

At step S3, the control circuitry 23 is configured to determine whether the first predetermined time period has elapsed. If the first predetermined time period has not elapsed (i.e., NO at step S3), then the method continues to keep checking until the first predetermined time period has elapsed.

When the first predetermined time period has elapsed at step S3 (i.e., YES at step S3), at step S4 the control circuitry 23 is configured to cause an indicator unit 31 to output an indicator signal to the user signifying the aerosol provision device 2 is ready to use, i.e., that the user is able to inhale on the aerosol provision device 2. In FIG. 4b, this time is signified by time tₚ, which is used herein to denote the time at which a user may start to puff. At this time, the indicator signal is output signifying to a user that they may begin puffing on the device to receive an aerosol.

In FIG. 1, the indicator unit 31 is an LED or other light emitting component configured to output an optical signal acting as the indication to the user. However, in other implementations, the indicator unit 31 may comprise any mechanism which is capable of supplying a signal to a user; that is, the indicator unit 31 may be an optical element to deliver an optical signal, a sound generator to deliver an aural signal, and/or a vibrator to deliver a haptic signal. In some implementations, the indicator unit 31 may be combined or otherwise provided by the touch-sensitive panel 29 (e.g., if the touch-sensitive panel includes a display element).

It should be appreciated that the signal output by the indicator unit 31 acts as a suggestion to the user that the aerosol provision device 2 is ready to be used. In some implementations, the user may inhale on the aerosol provision device 2 before the indicator signal is output, however the user is unlikely to receive a satisfactory experience in such an instance as the energy imparted to the aerosol generating material 44 may not be sufficient at that time to generate sufficient aerosol. However, in other implementations, the aerosol provision device 2 may include a flow restrictor or diverter (not shown) which acts to block the outlet 28 or divert flow around the receptacle 25 such that the user cannot inhale on the aerosol provision device 2 until the first predetermined time period has elapsed. In some implementations, the flow restrictor or diverter may provide the signal to the user signifying the aerosol provision device 2 is ready to use, i.e., the signal may be an inhalation dependent signal provided orally in the form of a change in the taste, temperature or flow resistance. In such instances the signal may be imperceptible to the user unless they inhale on the aerosol provision device 2 during the first predetermined time period.

The first predetermined time period may also be referred to herein as the delay time (or t_{delay}), as the first predetermined time period can be thought of as the time delay between the user initiating heating and the time the user begins inhaling.

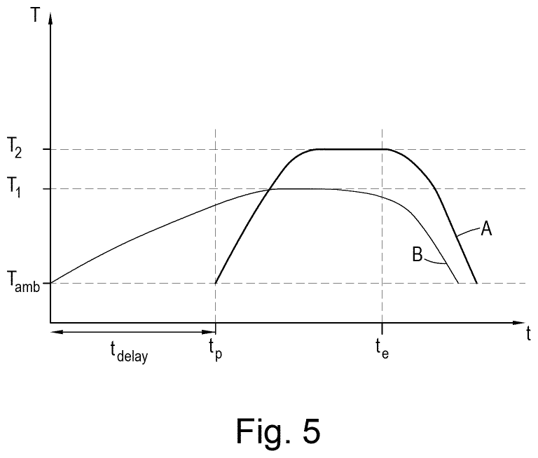

As seen in FIG. 4b, the operational temperature of the heating element 24 may be reached at a time t1 earlier than tₚ. However, the predetermined time period t_{delay} is set such that the aerosol generating material 44 is brought up to a suitable temperature and thus the (average) temperature of the aerosol generating material 44 may not match the temperature of the heating element 24 (see FIG. 5 for example, which is a graphical depiction of the temperatures of the aerosol generating material 44 in an embodiment). In some implementations, t1 may be the same as tₚ.

After step S4, in some implementations, the method may proceed to step S5 where the control circuitry 23 determines whether or not a second predetermined time period has elapsed. The second predetermined time period may be set in advance and may broadly correspond with the length of time of a typical inhalation. Typically the second predetermined time period will be on the order of 2 to 5 seconds, and in most implementations will be no longer than 10 seconds. In FIG. 4b, the time tₑ signifies the end of typical puff and may be set to, for example, 10 seconds or less after the time tₚ.

If the control circuitry 23 determines that the second predetermined time period has not yet elapsed (i.e., NO at step S5), then the method continues to keep checking until the second predetermined time period has elapsed. During this time, the control circuitry 23 may continue to heat the aerosol generating material 44. If, on the other hand, the control circuitry 23 determines that the second predetermined time period has elapsed, then the method proceeds to step S6 where the power supply to the heating element is stopped. As shown in FIG. 4b, the heating element temperature may steadily drop after tₑ to the ambient temperature or a pre-heat temperature. The control circuitry 23 may then continue to monitor for signaling signifying the user's intention to inhale aerosol again, and the method proceeds back to step S1.

In other implementations, as shown in FIG. 4a, at step S4 the method may instead or simultaneously proceed to step S7. At step S7, the control circuitry 23 monitors for a signal received from inhalation sensor 30 signifying that the user is inhaling on the aerosol provision device 2. When the control circuitry 23 receives the signal (i.e., YES at step S8), the control circuitry 23 proceeds to step S8 where the control circuitry 23 monitors for the absence of a puff (i.e., when signaling is no longer output from inhalation sensor 30). When the control circuitry 23 determines that the puff has stopped (or the user has stopped inhaling), the method proceeds to step S6 as described above. In this regard, tₑ in FIG. 4b would not represent a predetermined time period but a user dependent time and correlates with the end of the user's puff. In some implementations, a protection threshold may be employed, which may be a threshold on the order of 10 seconds or so. From the moment that the control circuitry 23 determines that the first predetermined time period has elapsed, the control circuitry 23 is configured to check whether the protection threshold has elapsed, and if so, the method proceeds to step S6. This may be used such that if a puff is not detected at step S7, or if the puff continues for too long at step S8, the aerosol generating material 44 does not overheat.

In accordance with the principles of the present disclosure, when a user receives the indication at step S4 and time tₚ, the user may start to inhale on the aerosol provision device 2. The second predetermined time period and/or the puff detection is set such that heating continues to occur as the user is inhaling on the aerosol provision device 2 and stops at a time broadly corresponding to the end of their inhalation. That is, heating is started before the inhalation and during the inhalation, but preferably stops at or around the time when the inhalation stops. This makes most efficient use of the aerosol generating material 44 and of the power source 22.

In some implementations, the control circuitry is configured to deliver the same level of power to the heating element during the first predetermined time period and during the second predetermined time period. In other words, in these implementations, a certain level of power is supplied from the moment the control circuitry 23 receives the signaling indicating the user's desire to inhale aerosol and this level of power is supplied continuously. In other implementations, the level of power supplied to the heating element 26 may vary between the first and second predetermined time periods. In yet other implementations, the level of power supplied to the heating element 24 may vary during the first and/or second predetermined time periods. Generally speaking, however, in either of the first and second predetermined time periods, the level of power supplied is sufficient to cause the heating element 24 to reach an operational temperature which causes aerosol to be generated from the aerosol generating material 44.

As should be appreciated from the above discussion, in some implementations, the operational temperature of the heating element 24 may be set based on the length of the first predetermined time period. For example, if the first predetermined time period is set to be relatively long, then the operational temperature can be set lower in order to provide a comparable amount of aerosol. (Alternatively, the operational temperature can be set lower, and the first predetermined time period set longer in order to provide a suitable amount of aerosol). Depending upon the aerosol generating material 44 that is being aerosolized, there may be a minimum temperature to consider below which aerosol is simply not generated (or not generated in noticeable quantities). For example, the minimum temperature may be around 150° C.

More generally, to a first approximation, the operational temperature, Tₒₚ, of the heating element can be set in accordance with the equation:

Tₒₚ=A−(B×t_{delay}),

where A and B are constants, and t_{delay} is the first predetermined time period. A and B may be determined empirically. A may be representative of the maximum temperature at which the given aerosol generating material 44 can be heated with a zero second puff delay without providing off-notes in the generated aerosol. For example, this might be around 290° C., although it should be appreciated this may vary depending upon the aerosol generating material 44 in question. B may be a scale factor and in this example, may be around 20. Hence, in this example, for a three second t_{delay}, Tₒₚ is equal to 230° C. Conversely, for a two second t_{delay}, Tₒₚ is equal to 250° C.

It should be appreciated that the formula given above may only provide a rough indication of heating element 24 operational temperatures. In other implementations, the relationship may not be modelled best by a linear equation, and a quadratic or higher order equation may be better suited to map the experimentally obtained data.

FIG. 5 is an exemplary graph showing the principles of the present disclosure. The graph is purely theoretical and does not represent physical data obtained, rather it is provided for explanatory purposes. The graph shows temperature T of the aerosol generating material 44 as a function to time t. Two curves are shown, A and B. The two curves represent heating profiles which would be considered to output roughly the same amount of aerosol from the same portion of aerosol generating material 44 for a given inhalation. Curve A is a curve obtained with a zero second delay (that is the first predetermined time period is zero). Curve B is a curve obtained where a non-zero delay, t_{delay}, is implemented from the initial point of heating. The graph shows two points in time: tₚ representing the start of a puff (or the start of the indicator signal), and tₑ representing the end of the puff or the end of the second predetermined time period.

Both curves A and B start out at an ambient temperature, T_{amb}, although as mentioned above there may be a pre-heating phase which generally warms the aerosol generating material 44 to a temperature above ambient but without generating aerosol to help improve responsiveness, such that the heating to an operational temperature at which aerosol is generated can be performed relatively quicker (thus meaning a shorter t_{delay} is possible). Curve A is heated from the point in time tₚ corresponding to the start of the puff and is heated up to an operational temperature of T₂. Curve B is heated more gradually over a longer time period and is heated to a lower operational temperature of T₁. To a first approximation, the area under the curves can be considered representative of the amount of aerosol generated as the temperature profile is a measure of the energy transferred to the aerosol generating portion. This may not be entirely accurate, however, as the efficiency of the transfer of energy may be dependent upon the temperature. Although not shown on the graph, as mentioned above, it should also be appreciated there is likely to be a minimum temperature below which aerosol is not generated. The area under the curves A and B may be broadly similar, thus suggesting that a similar mass of aerosol may be obtained by adjusting the heating time and correspondingly the operational temperature.

In an example, an amorphous solid (as the portion of aerosol generating material 44) was heated with a t_{delay} of 3 seconds and with a T_{delay} of 0 seconds at a range of different temperatures. The amorphous solid comprises about 20 wt % alginate gelling agent, about 48 wt % Virginia tobacco extract and about 32 wt % glycerol, wherein all percentages are measured on a dry weight basis. The portions of amorphous solid were identical.

A panel of 7 people were asked to inhale the aerosol generated and score the taste intensity and the visible aerosol where lower numbers signify a relatively poorer performance. The following table shows the average results:

| | Taste Intensity (average) | | Visible Aerosol (average) | |
|---|---|---|---|---|
| | Zero | Three | Zero | Three |
| Temperature | Second | Second | Second | Second |
| (° C.) | Delay | Delay | Delay | Delay |
| 210 | 2.2 | 3.6 | 0.6 | 0.4 |
| 230 | 2.5 | 4.2 | 0.4 | 0.7 |
| 250 | 3.0 | 4.4 | 1.2 | 1.2 |
| 270 | 3.5 | 3.5 | 1.4 | 0.6 |
| 290 | 4.4 | 3.0 | 1.8 | 1.1 |

The table above shows that the taste intensity for the aerosol generating material having the three second delay was much higher at lower temperatures, and at higher temperatures the taste intensity tailed off. It is thought this is because the longer heating time causes more of the material to vaporize and thus at higher temperatures (270° C. to 290° C.) a greater proportion of the formed aerosol condenses before the user can inhale the aerosol fully. As for visible aerosol, the aerosol generating material 44 having the three second delay performed better at 230° C. and comparably at 250° C.

Hence, based on this, in some implementations, especially those where the aerosol generating material 44 is an amorphous solid (such as the one described above), when the first predetermined time period is between 2 to 8 seconds, the heating element is heated to a temperature of between 200° C. to 270° C. In these implementations, the taste of the generated aerosol can be enhanced and/or different compared to heating at higher temperatures, albeit at the expense of adding a delay (increase) to the heating time.

In other implementations, especially those where the aerosol generating material 44 is an amorphous solid (such as the one described above), when the first predetermined time period is between 2 to 5 seconds, the heating element 24 is heated to a temperature of between 220° C. to 250° C. This may advantageously increase the visible aerosol and provide an improved taste profile.

In other implementations, especially those where the aerosol generating material 44 is an amorphous solid (such as the one described above), when the first predetermined time period is between 0 to 2 seconds (or more particularly greater than 0 and less than or equal to 2 seconds), the heating element 24 is heated to a temperature of greater than 270° C. In these implementations, the heating time delay is decreased such that the device is able to be used more quickly but still produce a suitable amount of aerosol.

More generally, when the first predetermined time period is greater than 0 seconds and less than 8 seconds, the heating element 24 is heated to a temperature of between 200° C. to 350° C. This has been found to provide a suitable aerosol for delivery to the user. In some implementations, especially those where the aerosol generating material 44 is an amorphous solid (such as the one described above), the heating element 24 is heated to a temperature of no greater than 350° C., or no greater than 320° C., or no greater than 300° C. Heating such an aerosol generating material 44 up to or beyond 350° C. is likely to lead to strong off-notes and unpleasant tastes generated in the aerosol due to charring of the aerosol generating material 44.

The disclosure above has focused on describing the interaction of a portion of aerosol generating material 44 with a heating element 24. However, as shown in FIG. 1, the aerosol provision device 2 may comprise a plurality of heating elements 24 each arranged to heat different portions of aerosol generating material 44. The following describes exemplary heating element 24 activation modes.

In some implementations, in response to detecting the signaling from the touch-sensitive panel 29, the control circuitry 23 is configured to sequentially supply power to each of the individual heating elements 24.

More specifically, the control circuitry 23 is configured to sequentially supply power to each of the individual heating elements 23 in response to a sequence of detections of the signaling received from the touch-sensitive panel 29. For example, the control circuitry 23 may be configured to supply power to a first heating element 24 of the plurality of heating elements 24 when the signaling is first detected (e.g., from when the aerosol provision device 2 is first switched on). When the inhalation stops, or in response to the predetermined time period from the signaling being detected elapsing, the control circuitry 23 registers that the first heating element 24 has been activated (and thus the corresponding discrete portion of aerosol generating material 44 has been heated). The control circuitry 23 determines that in response to receiving subsequent signaling from the touch-sensitive panel 29 that a second heating element 24 is to be activated. Accordingly, when the signaling from the touch-sensitive panel 29 is received by the control circuitry 23, the control circuitry 23 activates the second heating element 24. This process is repeated for remaining heating elements 24, such that all heating elements 24 are sequentially activated.

Effectively, this operation means that for each inhalation a different one of the discrete portions of aerosol generating material 44 is heated and an aerosol generated therefrom. In other words, a single discrete portion of aerosol generating material 44 is heated per user inhalation.

In other implementations, the control circuitry 23 may be configured to activate the first heating element 24 a plurality of times (e.g., two) before determining that the second heating element 24 should be activated in response to subsequent signaling from the touch-sensitive panel 29, or to activate each of the plurality of heating elements 24 once and when all heating elements 24 have be activated once, detection of subsequent signaling causes the heating elements 24 to be sequentially activated a second time.

Such sequential activations may be dubbed “a sequential activation mode”, which is primarily designed to deliver a consistent aerosol per inhalation (which may be measured in terms of total aerosol generated, or a total constituent delivered, for example). Hence, this mode may be most effective when each portion of the aerosol generating material 44 of the aerosol generating article 4 is substantially identical; that is, portions 44a to 44f are formed of the same material.

In some other implementations, in response to detecting the signaling from the touch-sensitive panel 29, the control circuitry 23 is configured to supply power to one or more of the heating elements 24 simultaneously.

In such implementations, the control circuitry 23 may be configured to supply power to selected ones of the heating elements 24 in response to a predetermined configuration. The predetermined configuration may be a configuration selected or determined by a user. For example, the touch-sensitive panel 29 may comprise a region that permits the user to individually select which of the heating elements 24 to activate when signaling from the touch-sensitive panel 29 is received by the control circuitry 23. In some implementations, the user may also be able to set the power level for each heating element 24 to be supplied to heating element 24 in response to receiving the signaling.

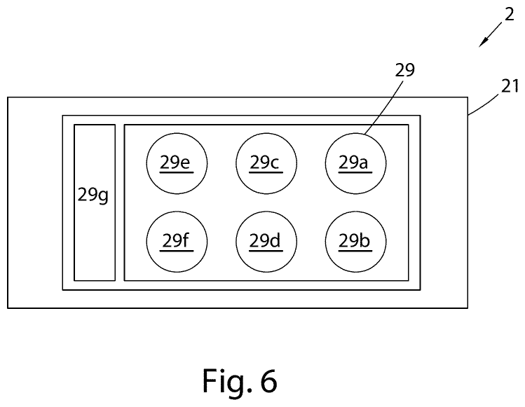

FIG. 6 is a top-down view of the touch-sensitive panel 29 in accordance with such implementations. FIG. 6 schematically shows outer housing 21 and touch-sensitive panel 29 of aerosol provision device 2 as described previously. The touch-sensitive panel 29 comprises six regions 29a to 29f which correspond to each of the six heating elements 24, and a region 29g which corresponds to the region for indicating that a user wishes to start inhalation or generating aerosol as described previously. The six regions 29a to 29f each correspond to touch-sensitive regions which can be touched by a user to control the power delivery to each of the six corresponding heating elements 24. In the described implementation, each heating element 24 can have multiple states, e.g., an off state in which no power is supplied to the heating element 24, a low power state in which a first level of power is supplied to the heating element 24, and a high power state in which a second level of power is supplied to the heating element 24 where the second level of power is greater than the first level of power. However, in other implementations, fewer or greater states may be available to the heating elements 24. For example, each heating element 24 may have an off state in which no power is supplied to the heating element 24 and an on state in which power is supplied to the heating element 24.

Accordingly, a user can set which heating elements 24 (and subsequently which portions of aerosol generating material 44) are to be heated (and optionally to what extent they are to be heated) by interacting with the touch-sensitive panel 29 in advance of generating aerosol. For example, the user may repeatedly tap the regions 29a to 29f to cycle through the different states (e.g., off, low power, high power, off, etc.). Alternatively, the user may press and hold the region 29a to 29f to cycle through the different states, where the duration of the press determines the state.

The touch-sensitive panel 29 may be provided with one or more indicators for each of the respective regions 29a to 29f to indicate which state the corresponding heating element 24 is currently in. For example, the touch-sensitive panel may comprise one or more LEDs or similar illuminating elements, and the intensity of the LEDs signifies the current state of the heating element 24. Alternatively, a colored LED or similar illuminating element may be provided and the color indicates the current state. Alternatively, the touch-sensitive panel 29 may comprise a display element (e.g., which may underlie a transparent touch-sensitive panel 29 or be provided adjacent to the regions 29a to 29f of the touch-sensitive panel 29) which displays the current state of the corresponding heating element 24.

When the user has set the configuration for the heating elements 24, in response to detecting the signaling from the touch-sensitive panel 29 (and more particularly region 29g of touch-sensitive panel 29), the control circuitry 23 is configured to supply power to the selected heating elements 24 in accordance with the pre-set configuration.

Accordingly, such simultaneous heating element 24 activations may be dubbed “a simultaneous activation mode”, which is primarily designed to deliver a customizable aerosol from a given aerosol generating article 4, with the intention of allowing a user to customize their experience on a session-by-session or even puff-by-puff basis. Hence, this mode may be most effective when portions of the aerosol generating material 44 of the aerosol generating article 4 are different from one another. For example, portions 44a and 44b are formed of one material, portions 44c and 44d are formed of a different material, etc. Accordingly, with this mode of operation, the user may select which portions of aerosol generating material 44 to aerosolize at any given moment and thus which combinations of aerosols to be provided with.

In both of the simultaneous and sequential activation modes, the control circuitry 23 may be configured to generate an alert signal which signifies the end of use of the aerosol generating article 4, for example when each of the heating elements 24 has been sequentially activated a predetermined number of times, or when a given heating element 24 has been activated a predetermined number of times and/or for a given cumulative activation time and/or with a given cumulative activation power. In FIG. 1, the aerosol provision device 2 includes indicator unit 31 which may also function to indicate the end of life of the aerosol generating article 4 (e.g., by outputting a different signal (an alert signal) to the signal output when the predetermined time period elapses). The aerosol provision device 2 may prevent subsequent activation of the aerosol provision device 2 when the alert signal is being output. The alert signal may be switched off, and the control circuitry 23 reset, when the user replaces the aerosol generating article 4 and/or switches off the alert signal via a manual means such as a button (not shown). The indicator unit 31 may therefore also be referred to as an end of life indicator 31. In other implementations, separate indicator units may output the respective signals.

In more detail, in implementations where the sequential mode of activation is employed, the control circuitry 23 may be configured to count the number of times signaling from either one or both of the touch-sensitive panel 29 and inhalation sensor 30 is received during a period of usage, and once the count reaches a predetermined number, the aerosol generating article 4 is determined to have reached the end of its life. For example, for an aerosol generating article 4 comprising six discrete portions of aerosol generating material 44, the predetermined number may be six, twelve, eighteen, etc. depending on the exact implementation at hand.

In implementations where the simultaneous mode of activation is employed, the control circuitry 23 may be configured to count the number of times one or each of the discrete portions of aerosol generating material 44 is heated. For example, the control circuitry 23 may count how many times a nicotine containing portion is heated, and when that reaches a predetermined number, determine an end of life of the aerosol generating article 4. Alternatively, the control circuitry 23 may be configured to separately count for each discrete portion of aerosol generating material 44 when that portion has been heated. Each portion may be attributed with the same or a different predetermined number and when any one of the counts for each of the portions of aerosol generating material 44 reaches the predetermined number, the control circuitry 23 determines an end of life of the aerosol generating article 4.

In either of the implementations, the control circuitry 23 may also factor in the length of time the portion of aerosol generating material 44 has been heated for and/or the temperature to which the portion of the aerosol generating material 44 has been heated. In this regard, rather than counting discrete activations, the control circuitry 23 may be configured to calculate a cumulative parameter indicative of the heating conditions experienced by each of the portions of aerosol generating material 44. The parameter may be a cumulative time, for example, whereby the temperature to which the aerosol generating material 44 is heated is used to adjust the length of time added to the cumulative time. For example, a portion of aerosol generating material 44 heated at 200° C. for three seconds may contribute three seconds to the cumulative time, whereas a portion of aerosol generating material 44 heated at 250° C. for three seconds may contribute four and a half seconds to the cumulative time.

The above techniques for determining the end of life of the aerosol generating article 4 should not be understood as an exhaustive list of ways of determining the end of life of the aerosol generating article 4, and in fact any other suitable way may be employed in accordance with the principles of the present disclosure.

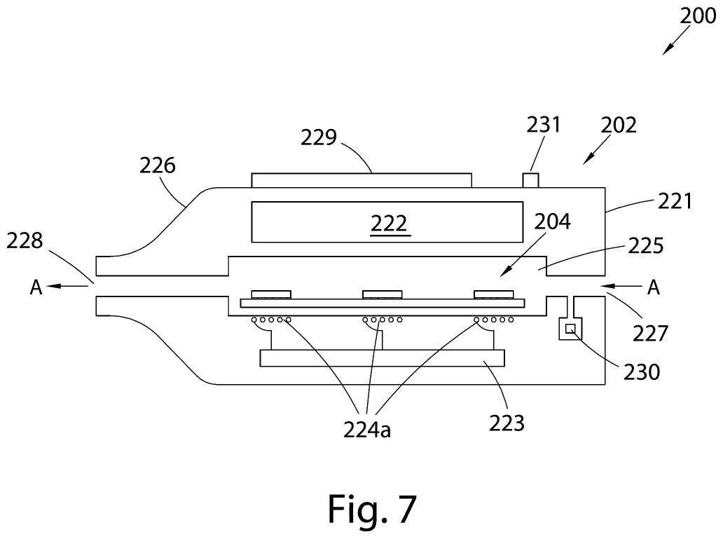

FIG. 7 is a cross-sectional view through a schematic representation of an aerosol provision system 200 in accordance with another embodiment of the disclosure. The aerosol provision system 200 includes components that are broadly similar to those described in relation to FIG. 1; however, the reference numbers have been increased by 200. For efficiency, the components having similar reference numbers should be understood to be broadly the same as their counterparts in FIGS. 1 and 2A to 2C unless otherwise stated.

The aerosol provision device 202 comprises an outer housing 221, a power source 222, control circuitry 223, induction work coils 224a, a receptacle 225, an inhalation or a mouthpiece end 226, an air inlet 227, an air outlet 228, a touch-sensitive panel 229, an inhalation sensor 230, and an end of use indicator 231.

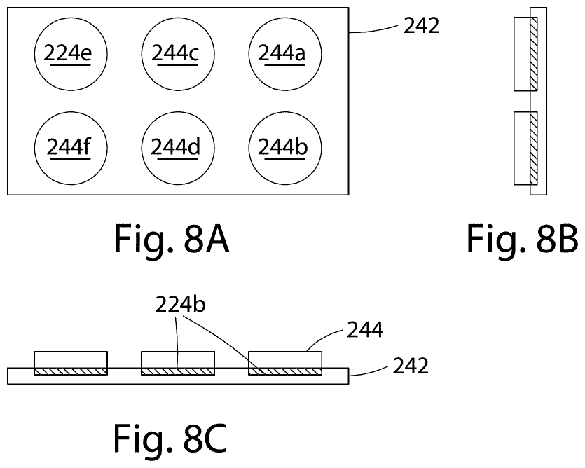

The aerosol generating article 204 comprises a carrier component 242, aerosol generating material 244, and susceptor elements 244b, as shown in more detail in FIGS. 8A to 8C. FIG. 8A is a top-down view of the aerosol generating article 204, FIG. 8B is an end-on view along the longitudinal (length) axis of the aerosol generating article 204, and FIG. 8C is a side-on view along the width axis of the aerosol generating article 204.

FIGS. 7 and 8 represent an aerosol provision system 200 which uses induction to heat the aerosol generating material 244 to generate an aerosol for inhalation.

In the described implementation, the aerosol generating component 224 is formed of two parts; namely, induction work coils 224a which are located in the aerosol provision device 202 and susceptors 224b which are located in the aerosol generating article 204. Accordingly, in this described implementation, each aerosol generating component 224 comprises elements that are distributed between the aerosol generating article 204 and the aerosol provision device 202.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In the described implementation, the susceptors 224b are formed from an aluminum foil, although it should be appreciated that other metallic and/or electrically conductive materials may be used in other implementations. As seen in FIG. 8, the carrier component 242 comprises a number of susceptors 224b which correspond in size and location to the discrete portions of aerosol generating material 244 disposed on the surface of the carrier component 242. That is, the susceptors 224b have a similar width and length to the discrete portions of aerosol generating material 244.

The susceptors 224b are shown embedded in the carrier component 242. However, in other implementations, the susceptors 224b may be placed on the surface of the carrier component 242.

The aerosol provision device 202 comprises a plurality of induction work coils 224a shown schematically in FIG. 7. The induction work coils 224a are shown adjacent the receptacle 225, and are generally flat coils arranged such that the rotational axis about which a given coil is wound extends into the receptacle 225 and is broadly perpendicular to the plane of the carrier component 242 of the aerosol provision article 204. The exact windings are not shown in FIG. 7 and it should be appreciated that any suitable induction coil may be used.

The control circuitry 223 comprises a mechanism to generate an alternating current which is passed to any one or more of the induction work coils 224a. The alternating current generates an alternating magnetic field, as described above, which in turn causes the corresponding susceptor(s) 224b to heat up. The heat generated by the susceptor(s) 224b is transferred to the portions of aerosol generating material 244 accordingly.

As described above in relation to FIGS. 1 and 2A to 2C, the control circuitry 223 is configured to supply current to the work coils 224a in response to receiving signaling from the touch sensitive panel 229 and/or the inhalation sensor 230. Any of the techniques for selecting which heating elements 24 are heated by control circuitry 23 as described previously may analogously be applied to selecting which work coils 224a are energized (and thus which portions of aerosol generating material 244 are subsequently heated) in response to receiving signaling from the touch sensitive panel 229 and/or the inhalation sensor 230 by control circuitry 223 to generate an aerosol for user inhalation.

Although the above has described an induction heating aerosol provision system where the work coils 224a and susceptors 224b are distributed between the aerosol generating article 204 and aerosol provision device 202, an induction heating aerosol provision system may be provided where the work coils 224a and susceptors 224b are located solely within the aerosol provision device 202. For example, with reference to FIG. 7, the susceptors 224b may be provided above the induction work coils 224a and arranged such that the susceptors 224b contact the lower surface of the carrier component 242 (in an analogous way to the aerosol provision system 1 shown in FIG. 1).

Thus, FIG. 7 describes a more concrete implementation where induction heating may be used in an aerosol provision device 202 to generate aerosol for user inhalation to which the techniques described in the present disclosure may be applied.

Although the above has described a system in which an array of aerosol generating components 24 (e.g., heating elements 24) are provided to energize the discrete portions of aerosol generating material 44, in other implementations, the aerosol generating article 4 and/or an aerosol generating component 24 may be configured to move relative to one another. That is, there may be fewer aerosol generating components 24 than discrete portions of aerosol generating material 44 provided on the carrier component 42 of the aerosol generating article 4, such that relative movement of the aerosol generating article 4 and aerosol generating components 24 is required in order to be able to individually energize each of the discrete portions of aerosol generating material 44. For example, a movable heating element 24 may be provided within the receptacle 25 such that the heating element 24 may move relative to the receptacle 25. In this way, the movable heating element 24 can be translated (e.g., in the width and length directions of the carrier component 42) such that the heating element 24 can be aligned with respective ones of the discrete portions of aerosol generating material 44. This approach may reduce the number of carrier components 42 required while still offering a similar user experience.

Although the above has described implementations where discrete, spatially distinct portions of aerosol generating material 44 are deposited on a carrier component 42, it should be appreciated that in other implementations the aerosol generating material 44 may not be provided in discrete, spatially distinct portions but instead be provided as a continuous sheet of aerosol generating material 44. In these implementations, certain regions of the sheet of aerosol generating material 44 may be selectively heated to generate aerosol in broadly the same manner as described above. However, regardless of whether or not the portions are spatially distinct, the present disclosure described heating (or otherwise aerosolizing) portions of aerosol generating material 44. In particular, a region (corresponding to a portion of aerosol generating material 44) may be defined on the continuous sheet of aerosol generating material 44 based on the dimensions of the heating element 24 (or more specifically a surface of the heating element 24 designed to increase in temperature). In this regard, the corresponding area of the heating element 24 when projected onto the sheet of aerosol generating material 44 may be considered to define a region or portion of aerosol generating material 44. In accordance with the present disclosure, each region or portion of aerosol generating material 44 may have a mass no greater than 20 mg; however the total continuous sheet of aerosol generating material may have a mass which is greater than 20 mg. Although the above has described implementations where the aerosol provision device 2 can be configured or operated using the touch-sensitive panel 29 mounted on the aerosol provision device 2, the aerosol provision device 2 may instead be configured or controlled remotely. For example, the control circuitry 23 may be provided with a corresponding communication circuitry (e.g., Bluetooth) which enables the control circuitry 23 to communicate with a remote device such as a smartphone. Accordingly, the touch-sensitive panel 29 may, in effect, be implemented using an App or the like running on the smartphone. The smartphone may then transmit user inputs or configurations to the control circuitry 23 and the control circuitry 23 may be configured to operate on the basis of the received inputs or configurations.

Although the above has described implementations in which an aerosol is generated by energizing (e.g., heating) aerosol generating material 44 which is subsequently inhaled by a user, it should be appreciated in some implementations that the generated aerosol may be passed through or over an aerosol modifying component to modify one or more properties of the aerosol before being inhaled by a user. For example, the aerosol provision device 2, 202 may comprise an air permeable insert (not shown) which is inserted in the airflow path downstream of the aerosol generating material 44 (for example, the insert may be positioned in the outlet 28). The insert may include a material which alters any one or more of the flavor, temperature, particle size, nicotine concentration, etc. of the aerosol as it passes through the insert before entering the user's mouth. For example, the insert may include tobacco or treated tobacco. Such systems may be referred to as hybrid systems. The insert may include any suitable aerosol modifying material, which may encompass the aerosol generating materials described above.

Although it has been described above that the heating elements 24 are arranged to provide heat to aerosol generating material 44 (or portions thereof) at an operational temperature at which aerosol is generated from the portion of aerosol generating material 44, in some implementations, the heating elements 24 are arranged to pre-heat portions of the aerosol generating material 44 to a pre-heat temperature (which is lower than the operational temperature). At the pre-heat temperature, a lower amount or no aerosol is generated when the portion is heated at the pre-heat temperature. In particular, in some implementations, the control circuitry is configured to supply power prior to the first predetermined time period starting (i.e., prior to receiving the signaling signifying a user's intention to inhale aerosol, as in step S1 above). However, a lower amount of energy is required to raise the temperature of the aerosol generating material 44 from the pre-heat temperature to the operational temperature, thus increasing the responsiveness of the system but at an increased total energy consumption. This may be particularly suitable for relatively thicker portions of aerosol generating material 44, e.g., having thicknesses above 400 which require relatively larger amounts of energy to be supplied in order to reach the operational temperature. In such implementations, the energy consumption (e.g., from the power source 22) may be comparably higher, however.

Although the above has described implementations in which the aerosol provision device 2 comprises an end of use indicator 31, it should be appreciated that the end of use indicator 31 may be provided by another device remote from the aerosol provision device 2. For example, in some implementations, the control circuitry 23 of the aerosol provision device 2 may comprise a communication mechanism which allows data transfer between the aerosol provision device 2 and a remote device such as a smartphone or smartwatch, for example. In these implementations, when the control circuitry 23 determines that the aerosol generating article 4 has reached its end of use, the control circuitry 23 is configured to transmit a signal to the remote device, and the remote device is configured to generate the alert signal (e.g., using the display of a smartphone). Other remote devices and other mechanisms for generating the alert signal may be used as described above.

In some implementations, the aerosol generating article 4 may comprise an identifier, such as a readable bar code or an RFID tag or the like, and the aerosol provision device 2 comprises a corresponding reader. When the aerosol generating article 4 is inserted into the receptacle 25 of the aerosol provision device 2, the aerosol provision device 2 may be configured to read the identifier on the aerosol generating article 4. The control circuitry 23 may be configured to either recognize the presence of the aerosol generating article 4 (and thus permit heating and/or reset an end of life indicator) or identify the type and/or the location of the portions of the aerosol generating material 44 relative to the aerosol generating article 4. This may affect which portions the control circuitry 23 aerosolizes and/or the way in which the portions are aerosolized, e.g., via adjusting the aerosol generation temperature and/or heating duration. Any suitable technique for recognizing the aerosol generating article 4 may be employed.

In addition, when the portions of aerosol generating material 44 are provided on a carrier component 42, the portions may, in some implementations, include weakened regions, e.g., through holes or areas of relatively thinner aerosol generating material 44, in a direction approximately perpendicular to the plane of the carrier component 42. This may be the case when the hottest part of the aerosol generating material 44 is the area directly contacting the carrier component (in other words, in scenarios where the heat is applied primarily to the surface of the aerosol generating material 44 that contacts the carrier component 42). Accordingly, the through holes may provide channels for the generated aerosol to escape and be released to the environment/the air flow through the aerosol provision device 2 rather than causing a potential build-up of aerosol between the carrier component 42 and the aerosol generating material 44. Such build-up of aerosol can reduce the heating efficiency of the aerosol provision system 1 as the build-up of aerosol can, in some implementations, cause a lifting of the aerosol generating material 44 from the carrier component 42 thus decreasing the efficiency of the heat transfer to the aerosol generating material 44. Each portion of aerosol generating material 44 may be provided with one of more weakened regions as appropriate.

Thus, there has been described a method of generating aerosol from aerosol generating material 44 using an aerosol provision device. The method comprises supplying power to a heating element to begin heating the aerosol generating material 44 to an operational temperature (e.g., a temperature at which aerosol is generated). After a first predetermined time period, the method provides a signal to a user to signify that the user may begin inhaling on the device. After a second predetermined time period or after a user has stopped inhaling, the method reduces the supply of power to the heating element. In this way a user can be guided as to when to inhale on a device. The timing may be adjusted to suit a particular delivery and/or device. Also described are an aerosol provision device and an aerosol provision system.

While the above described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A method of generating aerosol from aerosol generating material using an aerosol provision device, the method comprising:
supplying power to a heating element to begin heating the aerosol generating material to an operational temperature; and
after a first predetermined time period, providing a signal to a user to signify that the user may begin inhaling on the device; and
after a second predetermined time period or after a user has stopped inhaling, reducing the supply of power to the heating element.

2. The method of claim 1, wherein the operational temperature of the heating element is set based on the length of the first predetermined time period.

3. The method of claim 2, wherein the operational temperature, Tₒₚ, of the heating element is determined as follows:
Tₒₚ=A−(B×t_{delay}),
where A and B are constants, and t_{delay} is the first predetermined time period.

4. The method of claim 1, wherein when the first predetermined time period is greater than zero seconds and less than 8 seconds, the heating element is heated to an operational temperature of between 200° C. to 350° C.

5. The method of claim 1, wherein when the first predetermined time period is between 2 to 8 seconds, the heating element is heated to an operational temperature of between 200° C. to 270° C.

6. The method of claim 1, wherein when the first predetermined time period is between 2 to 8 seconds, the heating element is heated to an operational temperature of between 220° C. to 250° C.

7. The method of claim 1, wherein when the first predetermined time period is between 0 to 2 seconds, the heating element is heated to an operational temperature of greater than 250° C.

8. The method of claim 1, wherein the heating element is heated to an operational temperature of no greater than 350° C.

9. The method of claim 1, further comprising supplying power to the heating element prior to supplying power to the heating element during the first predetermined time period, wherein the power supplied prior to the first predetermined time period is set at a level such that the heating element is heated to a temperature below the operational temperature.

10. The method of claim 1, wherein the second predetermined time period is between 1 to 10 seconds.

11. The method of claim 1, wherein the aerosol generating material is an amorphous solid.

12. The method of claim 11, wherein the amorphous solid comprises: gelling agent in an amount of from about 1 wt % to about 60 wt %; tobacco extract in an amount of from about 10 wt % to about 60 wt %; aerosol generating agent in an amount of from about 5 wt % to about 60 wt %, wherein all percentages are measured on a dry weight basis.

13. The method of claim 11, wherein the thickness of the amorphous solid is between 0.05 mm to 0.4 mm.

14. The method of claim 1, wherein the signal is perceptible to the user by inhalation.

15. An aerosol provision device for generating aerosol from an aerosol generating material, the device comprising:
a heating element;
control circuitry; and
an indicator,
wherein the control circuitry is configured to:
supply power to the heating element to cause the heating element to begin heating the aerosol generating material to an operational temperature;
after a first predetermined time period, cause the indicator to provide a signal to a user to signify that the user may begin inhaling on the device; and
after a second predetermined time period or after a user has stopped inhaling, reducing the supply of power to the heating element.

16. The aerosol provision device of claim 15, wherein the operational temperature of the heating element is set based on the length of the first predetermined time period.

17. The aerosol provision device of claim 16, wherein the operational temperature, Tₒₚ, of the heating element is determined as follows:
Tₒₚ=A−(B×t_{delay}),
where A and B are constants, and t_{delay} is the first predetermined time period.

18. The aerosol provision device of claim 15, wherein when the first predetermined time period is greater than zero seconds and less than 8 seconds, the control circuitry is configured to cause heating of the heating element to an operational temperature of between 200° C. to 350° C.

19. The aerosol provision device of claim 15, wherein when the first predetermined time period is between 2 to 5 seconds, the control circuitry is configured to cause heating of the heating element to an operational temperature of between 200° C. to 270° C.

20. The aerosol provision device of claim 15, wherein when the first predetermined time period is between 2 to 5 seconds, the control circuitry is configured to cause heating of the heating element to an operational temperature of between 220° C. to 250° C.

21. The aerosol provision device of claim 15, wherein when the first predetermined time period is between 0 to 2 seconds, control circuitry is configured to cause heating of the heating element to an operational temperature of greater than 250° C. and/or greater than 270° C.

22. The aerosol provision device of claim 15, wherein the control circuitry is configured to cause heating of the heating element to an operational temperature of no greater than 350° C.

23. The aerosol provision device of claim 15, wherein the control circuitry is configured to supply power to the heating element prior to supplying power to the heating element for the first predetermined time period, wherein the power supplied prior to the first predetermined time period is set at a level such that the heating element is heated to a temperature below the operational temperature.

24. The aerosol provision device of claim 15, wherein the second predetermined time period is between 1 to 10 seconds.

25. The aerosol provision device of claim 15, wherein the signal is perceptible to the user by inhalation.

26. An aerosol provision system comprising an aerosol provision device and an aerosol generating material, the aerosol provision device comprising:
a heating element;
control circuitry; and
an indicator,
wherein the control circuitry is configured to:
supply power to the heating element to cause the heating element to begin heating the aerosol generating material to an operational temperature;
after a first predetermined time period, cause the indicator to provide a signal to a user to signify that the user may begin inhaling on the device; and
after a second predetermined time period or after a user has stopped inhaling, reducing the supply of power to the heating element.

27. The aerosol provision system of claim 26, wherein the aerosol generating material is an amorphous solid.

28. The aerosol provision system of claim 27, wherein the amorphous solid comprises: gelling agent in an amount of from about 1 wt % to about 60 wt %; tobacco extract in an amount of from about 10 wt % to about 60 wt %; aerosol generating agent in an amount of from about 5 wt % to about 60 wt %, all measured on a dry weight basis.

29. The aerosol provision system of claim 27, wherein the thickness of the amorphous solid is between 0.05 mm to 0.4 mm.

30. An aerosol provision device for generating aerosol from an aerosol generating material, the device comprising:
heating means;
control means; and
indicator means,
wherein the control means is configured to:
supply power to the heating means to cause the heating means to begin heating the aerosol generating material to an operational temperature;
after a first predetermined time period, cause the indicator means to provide a signal to a user to signify that the user may begin inhaling on the device; and
after a second predetermined time period or after a user has stopped inhaling, reducing the supply of power to the heating means.
